(19) United States
(12) Patent Application Publication
(10) Pub. No.: US 2018/0034744 A1
(43) Pub. Date: Feb. 1, 2018

(54) SYSTEM FOR PREDICTION OF RESOURCE ALLOCATION

(71) Applicant: BANK OF AMERICA CORPORATION, Charlotte, NC (US)

(72) Inventors: Katherine Dintenfass, Lincoln, RI (US); Victoria L. Dravneek, Charlotte, NC (US); Cameron D. Wadley, Waxhaw, NC (US); Amber J. Quitadamo, Woodstock, GA (US); Jason Christian Karmelek, Mendon, MA (US)

(21) Appl. No.: 15/224,020

(22) Filed: Jul. 29, 2016

(51) Int. Cl. H04L 12/911; H04L 29/08; G06N 5/04

(52) U.S. Cl. CPC H04L 47/823; G06N 5/04; H04L 67/10; H04L 67/143

(57) ABSTRACT

The invention provides for identifying an event associated with an entity and determining and/or predicting, for the event, the resources that need to be allocated for the event, the entities ability to perform the event based on the entities current input and output of resources and the entities ability to acquire resources to perform the event. In specific embodiments of the invention, third-party entities are identified for performing the event.

### FIELD OF THE INVENTION

The present invention is related to resource allocation and, more specifically, predicting resource allocation for an event including (i) the ability of an entity associated with the event to perform the event, (ii) the volume of resources needed for the entity to perform the event, and (iii) the ability of the entity to acquire the resources needed to perform the event.

### BACKGROUND

Entities encountered many events during the course of their existence that require resource allocation.

Therefore, a need exists to determine and/or predict, for such events, the volume of resources needed for the event, the entities ability to perform the event based on current resource input and output and the entities ability to acquire the resources needed to perform the event. In this regard, the desired systems and the like should continuously monitor parameters associated with these determinations and/or predictions, such that the results accurately show the requisite resources needed and the entity's ability to perform the event and acquire the resources needed to perform the event. In addition, a need exists to perform data comparisons between similarly-situated entities as a means of determining and predicting the resources needed for the event and the entity's ability to perform the event and acquire the resources needed to perform the event.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing systems, apparatus, methods computer program products and the like for determining and/or predicting, for an event associated with an entity, the resources that need to be allocated for the event, the entities ability to perform the event based on the entities current input and output of resources and the entities ability to acquire resources to perform the event.

A system for predicting resource allocation for an event defines first embodiments of the invention. The system includes a plurality of computing devices disposed across a distributed communication network, each of the devices including a computer platform including, a memory and at least one processor in communication with the memory. The system additionally includes one or more first databases stored in the memory, accessible via one or more of the processors and configured to store first data associated with an entity including resource distribution data associated with the entity. Additionally the system includes one or more second databases stored in the memory, accessible via one or more of the processors and configured to store data second data associated with a plurality of entities that are similarly situated as the entity and including resource distribution data associated with each of the plurality of entities. Further the system includes an event identifier module stored in memory, executable by one or more of the processors and configured to identify an event associated with an entity that requires a plurality of resources. In addition, the system includes a resource evaluation module stored in the memory, executable by one or more of the processors and configured to access the first and second databases and analyze at least a portion of the first and second data to predict (i) a first ability of the entity to perform the event, (ii) the volume of resources needed for the entity to perform the event, and (iii) a second ability of the entity to acquire the resources needed to perform the event.

In specific embodiments of the system, the resource evaluation module is further configured to analyze the at least a portion of the first and second data to determine the portion of the first and second data that is applicable to predicting one or more of (i) the first ability of the entity to perform the event, (ii) the volume of resources needed for the entity to perform the event, and (iii) the second ability of the entity to acquire the resources needed to perform the event.

In further specific embodiments of the system, the resource evaluation module is further configured to analyze the second data to determine which entities from amongst the plurality of entities to compare to the entity for the purpose of predicting one or more of (i) the first ability of the entity to perform the event based on current resource capability of the entity, (ii) the volume of resources needed for the event, and (iii) the second ability of the entity to acquire the resources needed to perform the event.

In other specific embodiments of the system, the resource evaluation module is further configured to access the first and analyze at least a portion of the first data to determine a second volume of resources that the entity is required to allocate for performing the event.

In still further specific embodiments of the system, the resource evaluation module is further configured to access the first databases and analyze at least a portion of the first data to predict the volume of resources needed for the entity to perform the event in comparison to current resources of the entity and current resource inflow of the entity.

In other specific embodiments of the system, the resource evaluation module is further configured access the first database and analyze at least a portion of the first data to identify future shortfalls in resource needs based on current resources of the entity, current resource inflow of the entity, current resource outflow of the entity and the volume of resources needed for the event.

In other embodiments of the system, the resource evaluation module is further configured to identify actions that can be taken by the entity to improve at least one of (i) the first ability of the entity to perform the event, and (ii) the second ability of the entity to acquire the resources needed to perform the event.

Moreover, in further embodiments the system includes an event provider determination module stored in the memory, executable by executable by one or more of the processors and configured to determine one or more third-party entities for providing at least a portion of the event to the entity.

A method for predicting resource allocation for an event defines second embodiments of the invention, The method includes providing a plurality of computing devices disposed across a distributed communication network, each of the devices including a computer platform including, a memory and at least one processor in communication with the memory. The method further includes providing one or more first databases stored in the memory, accessible via one or more of the processors and configured to store first data associated with an entity including resource distribution data associated with the entity and one or more second databases stored in the memory, accessible via one or more of the processors and configured to store data second data associated with a plurality of entities that are similarly situated as the entity and including resource distribution data associated with each of the plurality of entities. The method additionally includes identifying, by a computing device processor, an event associated with an entity that requires a plurality of resources. The method further includes accessing, by a computing device processor, the first and second databases and analyzing, by a computing device processor, at least a portion of the first and second data to predict (i) a first ability of the entity to perform the event, (ii) the volume of resources needed for the entity to perform the event, and (iii) a second ability of the entity to acquire the resources needed to perform the event.

In specific embodiments of the method, accessing and analyzing further includes analyzing, by the computing device processor, at least a portion of the first and second data to determine the portion of the first and second data that is applicable to predicting one or more of (i) the first ability of the entity to perform the event, (ii) the volume of resources needed for the entity to perform the event, and (iii) the second ability of the entity to acquire the resources needed to perform the event.

In other specific embodiments of the method, accessing and analyzing further includes analyzing, by the computing device processor, the second data to determine which entities from amongst the plurality of entities to compare to the entity for the purpose of predicting one or more of (i) the first ability of the entity to perform the event based on current resource capability of the entity, (ii) the volume of resources needed for the event, and (iii) the second ability of the entity to acquire the resources needed to perform the event.

In yet other specific embodiments of the method, accessing and analyzing further includes accessing, by the computing device processor, the first database and analyzing, by the computing device processor, at least a portion of the first data to determine a second volume of resources that the entity is required to allocate for performing the event.

In further specific embodiments of the method, accessing and analyzing further includes accessing, by the computing device processor, the first database and analyzing, by the computing device processor, at least a portion of the first data to predict the volume of resources needed for the entity to perform the event in comparison to current resources of the entity and current resource inflow of the entity.

Moreover, in further specific embodiments of the method accessing and analyzing further includes further comprising accessing, by the computing device processor, the first and second databases and analyzing, by the computing device processor, at least a portion of the first and second data to identify future shortfalls in resource needs based on current resources of the entity, current resource inflow of the entity, current resource outflow of the entity and the volume of resources needed for the event.

In additional specific embodiments the method further includes identifying, by a computing device processor, actions that can be taken by the entity to improve at least one of (i) the first ability of the entity to perform the event, and (ii) the second ability of the entity to acquire the resources needed to perform the event.

In other specific embodiments the method includes determining, by a computing device processor, one or more third-party entities for providing at least a portion of the event to the entity.

A computer program product for predicting resource allocation for an event defines third embodiments of the invention. The computer program product includes non-transitory computer-readable storage medium having computer-executable instructions. The instructions are configured for identifying an event associated with an entity that requires a plurality of resources and predicting (i) a first ability of the entity to perform the event, (ii) the volume of resources needed for the entity to perform the event, and (iii) a second ability of the entity to acquire the resources needed to perform the event.

In specific embodiments of the computer program product the instructions for predicting are further configured for determining which entities from amongst a plurality of entities to compare to the entity for the purpose of predicting one or more of (i) the first ability of the entity to perform the event based on current resource capability of the entity, (ii) the volume of resources needed for the event, and (iii) the second ability of the entity to acquire the resources needed to perform the event. In other related embodiments of the computer program product the instructions for predicting are further configured for predicting the volume of resources needed for the entity to perform the event in comparison to current resources of the entity and current resource inflow of the entity.

Thus, systems, apparatus, methods, and computer program products herein described in detail below provide for determining and/or predicting, for an event associated with an entity, the resources that need to be allocated for the event, the entities ability to perform the event based on the entities current input and output of resources and the entities ability to acquire resources to perform the event.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a schematic diagram of an exemplary system for identifying an event and predicting resource allocation for the event, in accordance with embodiments of the present invention;

FIG. 2 provides a block diagram of an apparatus for identifying an event and predicting resource allocation for the event, in accordance with embodiments of the present invention;

FIG. 3 provides a block diagram of an apparatus for identifying a life event and predicting the financial resources needed to be allocated to the life event, in accordance with embodiments of the present invention; and

FIG. 4 provides a flow diagram of a method system for identifying an event and predicting resource allocation for the event, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal allocation. Like numbers refer to like elements throughout.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

Thus, embodiments of the present invention provide for identifying an event associated with an entity and determining and/or predicting, for the event, the resources that need to be allocated for the event, the entities ability to perform the event based on the entities current input and output of resources and the entities ability to acquire resources to perform the event. In some embodiments of the invention third-party entities are determined for performing the event.

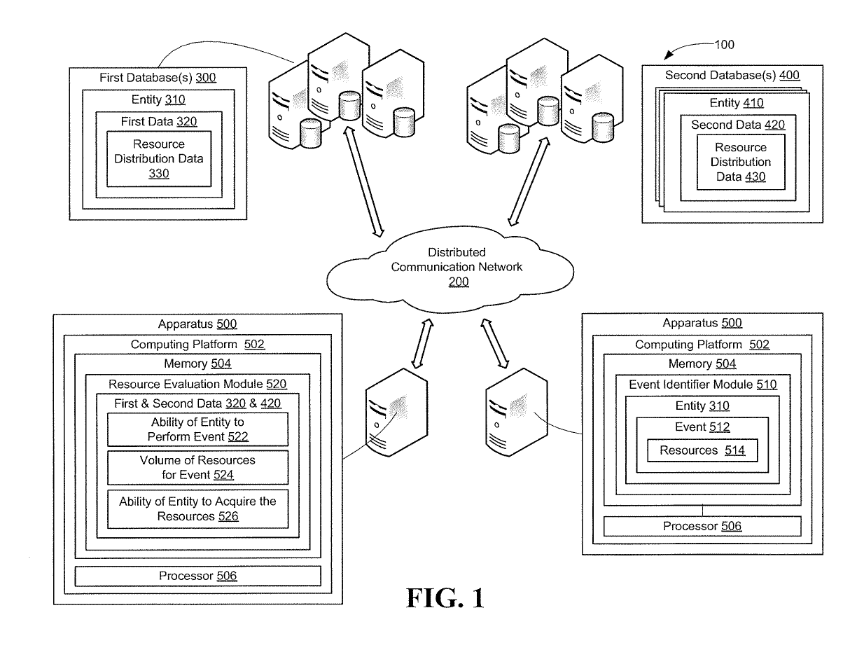

Referring to FIG. 1, a schematic diagram is provided of a system 100 for predicting resource allocation for event, in accordance with embodiments of the present invention. The system 100 is implemented in a distributed communication environment via computing network 200, which typically comprises an intranet and/or the Internet. System 100 includes one or more first databases 300 that are accessible via the distributed computing network 200 and are configured to store first data 310 associated with an entity 310 including resource distribution data 330 associated with the entity 310.

The system additionally includes second databases 400 that are accessible via the distributed computing network 200 and are configured to store second data 420 associated with a plurality of other entities, wherein at least a portion of the other entities are similarly situated, in terms of resources, as the entity, and the second data 420 includes resource distribution data 430 associated with each of the plurality of entities 410.

The system additionally includes apparatus 500 which may comprise one or more computing devices. As such, apparatus 500 includes a computing platform 502 having a memory 504 and at least one processor 506 in communication with the memory 504. Memory 504 stores event identifier module 510 that is executable by the processor 506 and configured to identify, or otherwise detect, an upcoming event 512 associated with the entity 310 that requires resources 514. In specific embodiments of the invention the entity 310 identifies the event 512. While in other embodiments of the invention the event 512 is identified/detected based on accessing the first data 320 associated with the entity 320 and identifying/detecting the event 512 based on the resource distribution data 330.

Memory 504 of apparatus 500 additionally stores resource evaluation module 520 that is configured to access the first and second databases 300 and 400 and analyze at least a portion of the first and second data 320 and 420 to predict (i) a first ability of the entity to perform the event 522, (ii) the volume of resources needed for the entity to perform the event 524, and (iii) a second ability of the entity to acquire the resources needed to perform the event 526.

In specific embodiments of the invention, as a result of predicting (i) a first ability of the entity to perform the event 522, (ii) the volume of resources needed for the entity to perform the event 524, and (iii) a second ability of the entity to acquire the resources needed to perform the event 526, a determination is made as which third-party entities may provide at least a portion of the event or which third-party entities may otherwise be selected to propose offering at least a portion of the event to the entity.

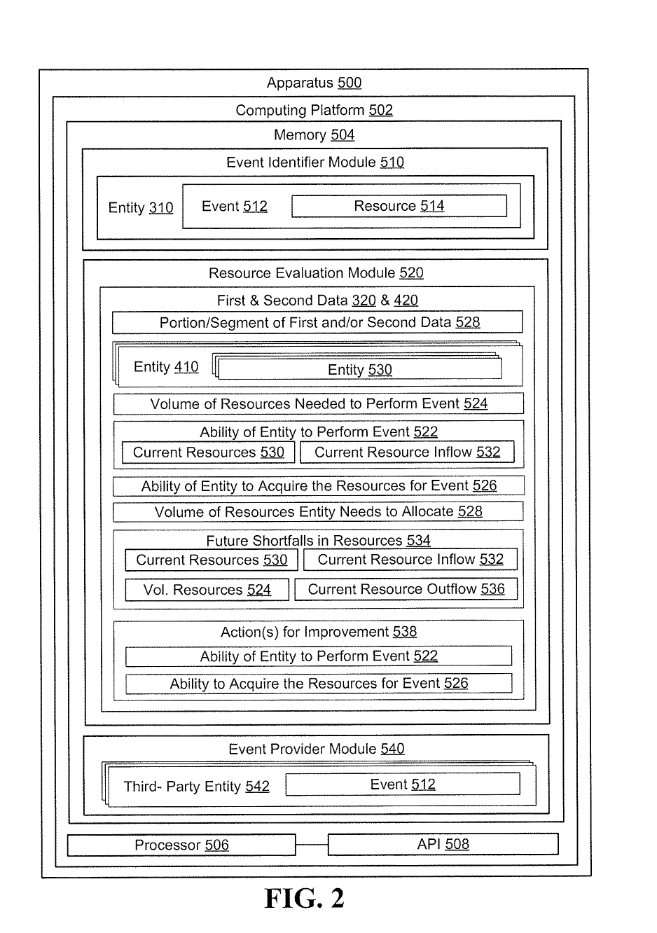

Referring to FIG. 2 a block diagram is presented of the apparatus 500, which is configured for identifying an event associated with an entity and predicting resource allocation associated with the event, in accordance with embodiments of the present invention. In addition to providing greater detail, FIG. 2 highlights various alternate embodiments of the invention. The apparatus 500 may include one or more of any type of computing device, such as one or more servers, personal computers or the like. The present apparatus and methods can accordingly be performed on any form of one or more computing devices.

The apparatus 500 includes a computing platform 502 that can receive and execute algorithms, such as routines, and applications. Computing platform 502 includes memory 504, which may comprise volatile and non-volatile memory, such as read-only and/or random-access memory (RAM and ROM), EPROM, EEPROM, flash cards, or any memory common to computer platforms. Further, memory 504 may include one or more flash memory cells, or may be any secondary or tertiary storage device, such as magnetic media, optical media, tape, or soft or hard disk. Moreover, memory 504 may comprise cloud storage, such as provided by a cloud storage service and/or a cloud connection service.

Further, computing platform 502 also includes processor 506, which may be an application-specific integrated circuit (“ASIC”), or other chipset, processor, logic circuit, or other data processing device. Processor 506 or other processor such as ASIC may execute an application programming interface (“API”) 508 that interfaces with any resident programs, such as event identifier module 510, resource evaluation module 520 and event provider module 540 and routines, sub-modules associated therewith or the like stored in the memory 504 of the apparatus 500.

Processor 506 includes various processing subsystems (not shown in FIG. 2) embodied in hardware, firmware, software, and combinations thereof, that enable the functionality of apparatus 500 and the operability of the apparatus 500 on a network 200. For example, processing subsystems allow for initiating and maintaining communications and exchanging data with other networked devices, such as those databases 300 and 400 shown in FIG. 1. For the disclosed aspects, processing subsystems of processor 506 may include any subsystem used in conjunction with event identifier module 510, resource evaluation module 520 and event provider module 540 and related algorithms, sub-algorithms, modules, sub-modules thereof.

Computer platform 502 may additionally include communications module (not shown in FIG. 2) embodied in hardware, firmware, software, and combinations thereof, that enables communications among the various components of the apparatus 500, as well as between the other networked devices. Thus, communication module may include the requisite hardware, firmware, software and/or combinations thereof for establishing and maintaining a network communication connection.

The memory 504 of apparatus 500 stores event identifier module 510 that is executable by the processor 506 and configured to identify, or otherwise detect, an upcoming event 512 associated with the entity 310 that requires resources 514. In specific embodiments of the invention the entity 310 identifies the event 512. While in other embodiments of the invention the event 512 is identified/detected based on accessing the first data 320 associated with the entity 320 and identifying/detecting the event 512 based on the resource distribution data 330.

The memory 504 of apparatus 500 additionally stores life event funding evaluation module 520 that is configured to access the first and second databases 300 and 400 and analyze at least a portion of the first and second data 320 and 420 to predict (i) a first ability of the user to finance/afford the life event 522, (ii) the volume of finances needed for the user to fund the life event 524, and (iii) a second ability of the entity to acquire the funds needed to perform the event (i.e., the credit worthiness of the user) 526.

In specific embodiments of the invention, the life event funding evaluation module 520 is further configured to determine which portion or segment 528 of the first and/or second data 320 and 420 is used to predict (i) a first ability of the user to finance/afford the life event 522, (ii) the volume of finances needed for the user to fund the life event 524, and (iii) a second ability of the entity to acquire the funds needed to perform the event (i.e., the credit worthiness of the user) 526. The determination as to which portion or segment 528 of the first and/or second data 320 and 420 is used may be based on the type of event, the resources needed to perform the event, the timing of the event and the like. In addition, the resource evaluation module 520 is further configured to determine which entities 530 from amongst the plurality of entities 410 to compare to the entity 310 for the purpose of predicting one or more of (i) the first ability of the entity to perform the event based on current resource capability of the entity 522, (ii) the volume of resources needed for the event 524, and (iii) the second ability of the entity to acquire the resources needed to perform the event 526. The determination of which entities 530 from amongst the plurality of entities 410 to compare to the entity 310 is based on which of the entities 530 are similarly situated, in terms of the event 512, to the entity 310. For example, which of the entities 530 have previously performed the event 512, which of the entities 530 have similar resources available and/or similar resource inflow and/or outflow, which of the entities 530 are located proximate to the entity 310 and the like.

In specific embodiments of the invention, the resource evaluation module 520 is further configured to access the first database 300 and analyze at least a portion of the first data 320 to determine a second volume 528 of resources that the entity needs or is otherwise required, to allocate for performing the event.

In further embodiments of the invention, the resource evaluation module 520 is configured to access the first database 300 and analyze at least a portion of the first data 320 to predict the ability of the entity to perform the event 522 by assessing current resources of the entity 530 and current resource inflow 532 of the entity in comparison to current resource outflow 536 of the entity. In other related embodiments of the invention, the resource evaluation module is further configured access the first database 300 and analyze at least a portion of the first data 320 to identify future shortfalls in resources needs 534 to perform the event based on current resources of the entity 530, current resource inflow of the entity 532, current resource outflow 536 of the entity and the volume of resources 524 needed for the event.

In other optional embodiments of the invention, the resource evaluation module 520 is further configured to identify improvement actions 538 that can be taken by the entity 310 to improve at least one of (i) the first ability of the entity to perform the event 522, and/or (ii) the second ability of the entity to acquire the resources needed to perform the event 526.

In other alternate embodiments of the invention, the memory 504 of apparatus 500 stores event provider module 540 that is executable by the processor 506 and configured to determine one or more third-party entities 542 for providing at least a portion of the event 512 to the entity 310.

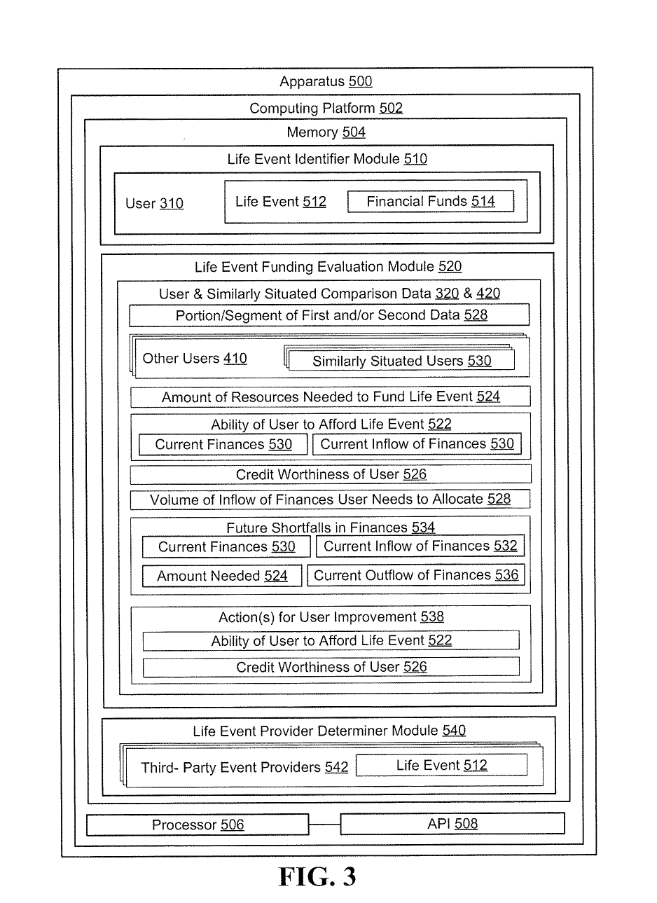

Referring to FIG. 3 a block diagram is shown of an apparatus 300 for identifying events and predicting resource allocation, in accordance with specific embodiments of the present invention. In accordance with the embodiments shown and discussed in relation to Similar to the apparatus 300 shown and discussed in FIGS. 1 and 2, the apparatus 300 of FIG. 3 may comprise one or more computing devices and includes a computing platform 302 having a memory 304 and at least one processor 306 in communication with the memory.

The memory 304 of apparatus 300 stores life event identifier module 510 that is configured to identity, or otherwise detect, an upcoming life event associated with a user that requires financial funds. For example, the life event may be moving to a new city, a marriage/wedding, purchasing/leasing a vehicle, purchasing/renting a home or the like. In specific embodiments of the invention, the life event identifier module 510 may be configured to receive user inputs that identify the life event 512 and timelines or the like for conducting/completing the life event 512. In other embodiments of the invention, life event identifier module 510 is configured to automatically detect upcoming life events 512. In such embodiments of the invention, life event identifier module 510 may be configured to access first databases 300 that store first data associated with the user 310 including resource distribution data 330. In such embodiments of the invention, the first databases 300 may comprise financial institution transaction databases that store the user's historical transaction data. In such embodiments of the invention, the user's historical transaction data may be used, in conjunction with other known data about the user, to detect and define an upcoming life event 512. The user's historical transaction data may indicate items/services purchased, dates of purchase, as well as dates of use, item-level purchase amounts and the like.

Additionally, memory 504 of apparatus 500 stores life event funding evaluator module 520 that is configured to access the first data 320 (i.e., user-related data) and second data 420 (i.e., other users similarly situated to the entity) and use at least a portion of the first and second data to predict (i) the amount of financial funds 524 needed or otherwise required by the user 310 to conduct the life event 512, (ii) the ability of the user to afford/finance 522 the life event 512, and (iii) the credit worthiness 526 of the user 310. In specific embodiments of the invention, the ability of the user to afford/finance 522 the life event 512 takes into account the current user's finances 530, current inflow of finances 532 (e.g., current salary or the like), current outflow of finances 538 (e.g., current mortgage/rent, vehicle payments, loan payments and other recurring payments and the like). In other specific embodiments of the invention, the credit worthiness 526 of the user takes into account the user's current credit rating/score(s) and the like. For example, first data 320 associated with the user may include user profile data, as well as user transaction data. The profile data may be relied on to show the user's demographics (e.g., age range, location, income range and the like) and the transaction data may be relied to determine what the user typically spends on different item types (i.e., how much do they typically spend for a vacation, vehicle and the like).

In specific embodiments of the invention, the life event funding evaluation module 520 is further configured to determine which portion or segment 528 of the first and/or second data 320 and 420 is used to predict (i) a first ability of the user to finance/afford the life event 522, (ii) the volume of finances needed for the user to fund the life event 524, and (iii) a second ability of the entity to acquire the funds needed to perform the event (i.e., the credit worthiness of the user) 526. The determination as to which portion or segment 528 of the first and/or second data 320 and 420 is used may be based on the type of life event 512, the funds 514 needed to perform the life event 512, the timing of the life event (e.g., how soon in the future the life event will occur) and the like.

In addition, the life event funding evaluation module 520 is further configured to determine which users 530 from amongst the plurality of users 410 to compare to the user 310 for the purpose of predicting one or more of (i) the ability of the entity to afford the life event 522 based on current finances, inflow/outflow of finances of the user, (ii) the finances needed/required to perform/conduct the life event 524, and (iii) the credit worthiness 526 of the user. The determination of which users 530 from amongst the plurality of users 410 to compare to the user 310 is based on which of the users 530 are similarly situated, in terms of the life event 530, to the user 310. For example, which of the users 530 have previously performed the life event 512 (e.g., moved from the same location to the same desired location, purchased a similar home and the like) which of the users 530 have similar finances available and/or similar inflow and/or outflow of finances, which of the users 530 are located/reside proximate to the user 310 and the like.

In specific embodiments of the invention, the life event funding evaluation module 520 is further configured to access the first database 300 and analyze at least a portion of the first data 320 to determine a second amount or percentage 528 of finances that the user should allocate for performing the event. The second amount takes in to account the user's current cash inflow versus outflow, current finance reserve/savings and the like, and takes into account user profile data, such as age, location, and the like.

In further embodiments of the invention, the life event funding evaluation module 520 is configured to access the first database 300 and analyze at least a portion of the first data 320 to predict the ability of the user to perform the life event 522 by assessing current funds available to the user 530 and current financial inflow 532 of the user 310 in comparison to current financial outflow 536 of the user. In other related embodiments of the invention, the life event funding evaluation module 520 is further configured access the first database 300 and analyze at least a portion of the first data 320 to identify future shortfalls in finances 534 needed to perform the life event 512 based on (i) current funds available to the user 530, current financial inflow 532 of the user 310, current financial outflow 536 of the user and the amount of finances 524 needed for the life event 512.

In other optional embodiments of the invention, the life event funding evaluation module 520 is further configured to identify improvement actions 538 that can be taken by the user 310 to improve at least one of (i) the ability of the user to afford/fund the life event 522, and/or (ii) the credit worthiness 526 of the user.

In other alternate embodiments of the invention, the memory 504 of apparatus 500 stores life event provider module 540 that is executable by the processor 506 and configured to determine one or more third-party entities 542 for providing at least a portion of the life event 512 to the entity 310. The life event provider module 540 may rely on the user data and/or or the data of those users who are determined to be similarly situated (e.g., users who previously performed/financed the life event or the like) to determine which third-party entities 542 are best suited to provide the life event 512, or a portion of the like event 512 to the user. Additionally, the life event provider module 540 may rely on any of the predictions and/or determinations provided by the life event funding evaluation module 520 in determining which third-parties should provide the life event 512 or be offered the opportunity to provide the life event 512 (i.e., the opportunity to solicit the user or the like). In addition, the determination of third-party entities 542 may take into account offers and/or discounts that may offered to the user 310 and/or affiliations with the entity (e.g., financial institution or the like) implementing the life event identifier module 510 and the life event funding evaluation module 520.

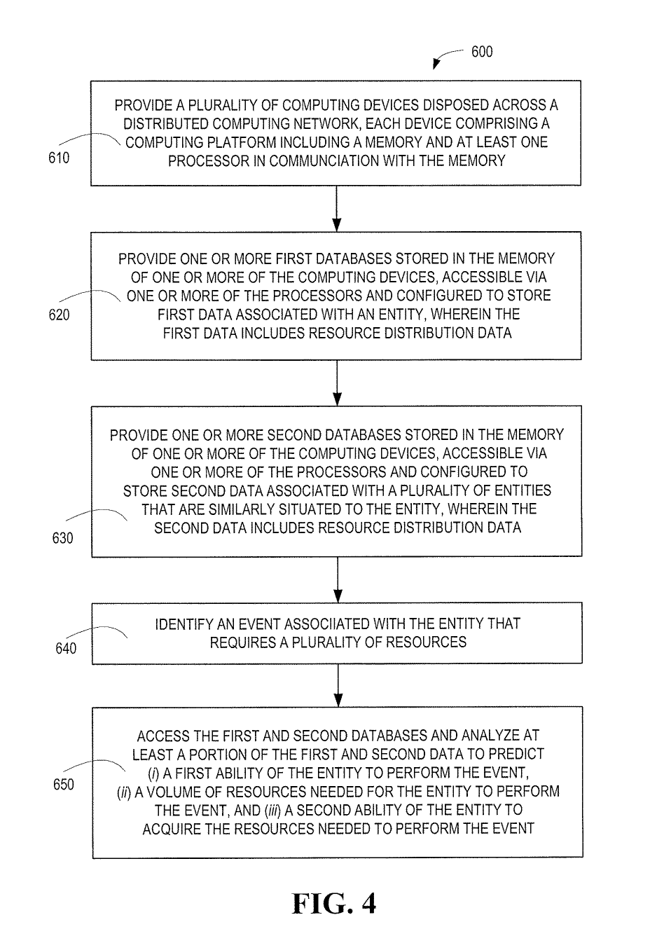

Referring to FIG. 4 a flow diagram is depicted of a method 600 for identify an event and predicting resource allocation for the event, in accordance with embodiments of the present invention. At Event 610, a plurality of communication devices are provided that are disposed across a distributed communication network, such as an intranet, the Internet, a combination of an intranet and the Internet or the like. The communication devices include a computing platform having a memory and at least one processor in communication with the memory.

At Event 620, one or more first databases are provided within the distributed computing network such that they are stored in the memory of one or more of the computing devices and are accessible via one or more of the processors. The first databases are configured to store first data associated with the entity/user that desires to perform the event. Additionally, the first data includes resource distribution data (i.e., data associated with previous distribution of resources by the entity).

At Event 630, one or more second databases are provided within the distributed computing network such that they are stored in the memory of one or more of the computing devices and are accessible via one or more of the processors. The second databases are configured to store second data associated with a plurality of other entities/users that similarly situated to the user for purposes of the event. (i.e., previously performed on conducted the same or similar event or the like). Additionally, the second data includes resource distribution data (i.e., data associated with previous distribution of resources by the other entities, include previous distributions associated with the same or similar events).

At Event 640, an event associated with the entity is identified or otherwise detected. The event may be identified based on the entity identifying/defining the event or, in other embodiments of the invention, the event, along with parameters such as the timing of the event and the like, are identified/detected based on accessing the first data associated with the entity and identifying/detecting the event based on the resource distribution data.

At Event 650, the first and second databases are accessed and at least a portion of the first and second data is analyzed to predict (i) a first ability of the entity to perform the event 522, (ii) the volume of resources needed for the entity to perform the event 524, and (iii) a second ability of the entity to acquire the resources needed to perform the event 526. In specific embodiments of the invention, as a result of predicting (i) a first ability of the entity to perform the event 522, (ii) the volume of resources needed for the entity to perform the event 524, and (iii) a second ability of the entity to acquire the resources needed to perform the event 526, a further determination may be made as to which third-party entities are best suited to perform at least a portion of the event and/or which of the third-party entities may offer to the entity to perform at least a portion of event.

Thus, systems, apparatus, methods, and computer program products described above provide for identifying an event associated with an entity and determining and/or predicting, for the event, the resources that need to be allocated for the event, the entities ability to perform the event based on the entities current input and output of resources and the entities ability to acquire resources to perform the event. In specific embodiments of the invention, third-party entities are identified for performing the event. While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for predicting resource allocation for an event, the system comprising:
a plurality of computing devices disposed across a distributed communication network, each of the devices comprising a computer platform including, a memory and at least one processor in communication with the memory;
one or more first databases stored in the memory, accessible via one or more of the processors and configured to store first data associated with an entity including resource distribution data associated with the entity;
one or more second databases stored in the memory, accessible via one or more of the processors and configured to store data second data associated with a plurality of entities that are similarly situated as the entity and including resource distribution data associated with each of the plurality of entities;
an event identifier module stored in memory, executable by one or more of the processors and configured to identify an event associated with an entity that requires a plurality of resources;
a resource evaluation module stored in the memory, executable by one or more of the processors and configured to access the first and second databases and analyze at least a portion of the first and second data to predict (i) a first ability of the entity to perform the event, (ii) a volume of resources needed for the entity to perform the event, and (iii) a second ability of the entity to acquire the resources needed to perform the event.

2. The system of claim 1, wherein the resource evaluation module is further configured to analyze the at least a portion of the first and second data to determine the portion of the first and second data that is applicable to predicting one or more of (i) the first ability of the entity to perform the event, (ii) the volume of resources needed for the entity to perform the event, and (iii) the second ability of the entity to acquire the resources needed to perform the event.

3. The system of claim 1, wherein the resource evaluation module is further configured to analyze the second data to determine which entities from amongst the plurality of entities to compare to the entity for the purpose of predicting one or more of (i) the first ability of the entity to perform the event based on current resource capability of the entity, (ii) the volume of resources needed for the event, and (iii) the second ability of the entity to acquire the resources needed to perform the event.

4. The system of claim 1, wherein the resource evaluation module is further configured to access the first database and analyze at least a portion of the first data to determine a second volume of resources that the entity is required to allocate for performing the event.

5. The system of claim 1, wherein the resource evaluation module is further configured to access the first database and analyze at least a portion of the first data to predict the volume of resources needed for the entity to perform the event in comparison to current resources of the entity and current resource inflow of the entity.

6. The system of claim 1, wherein the resource evaluation module is further configured access the first database and analyze at least a portion of the first data to identify future shortfalls in resource needs based on current resources of the entity, current resource inflow of the entity, current resource outflow of the entity and the volume of resources needed for the event.

7. The system of claim 1, wherein the resource evaluation module is further configured to identify actions that can be taken by the entity to improve at least one of (i) the first ability of the entity to perform the event, and (ii) the second ability of the entity to acquire the resources needed to perform the event.

8. The system of claim 1, further comprising an event provider determination module stored in the memory, executable by executable by one or more of the processors and configured to determine one or more third-party entities for providing at least a portion of the event to the entity.

9. A method for predicting resource allocation for an event, the method comprising:
providing a plurality of computing devices disposed across a distributed communication network, each of the devices comprising a computer platform including, a memory and at least one processor in communication with the memory;
providing one or more first databases stored in the memory, accessible via one or more of the processors and configured to store first data associated with an entity including resource distribution data associated with the entity;
providing one or more second databases stored in the memory, accessible via one or more of the processors and configured to store data second data associated with a plurality of entities that are similarly situated as the entity and including resource distribution data associated with each of the plurality of entities;
identifying, by a computing device processor, an event associated with an entity that requires a plurality of resources;
accessing, by a computing device processor, the first and second databases and analyzing, by a computing device processor, at least a portion of the first and second data to predict (i) a first ability of the entity to perform the event, (ii) a volume of resources needed for the entity to perform the event, and (iii) a second ability of the entity to acquire the resources needed to perform the event.

10. The method of claim 9, wherein accessing and analyzing further comprises analyzing, by the computing device processor, at least a portion of the first and second data to determine the portion of the first and second data that is applicable to predicting one or more of (i) the first ability of the entity to perform the event, (ii) the volume of resources needed for the entity to perform the event, and (iii) the second ability of the entity to acquire the resources needed to perform the event.

11. The method of claim 9, wherein accessing and analyzing further comprises analyzing, by the computing device processor, the second data to determine which entities from amongst the plurality of entities to compare to the entity for the purpose of predicting one or more of (i) the first ability of the entity to perform the event based on current resource capability of the entity, (ii) the volume of resources needed for the event, and (iii) the second ability of the entity to acquire the resources needed to perform the event.

12. The method of claim 9, wherein accessing and analyzing further comprises accessing, by the computing device processor, the first database and analyzing, by the computing device processor, at least a portion of the first data to determine a second volume of resources that the entity is required to allocate for performing the event.

13. The method of claim 9, wherein accessing and analyzing further comprises accessing, by the computing device processor, the first database and analyzing, by the computing device processor, at least a portion of the first data to predict the volume of resources needed for the entity to perform the event in comparison to current resources of the entity and current resource inflow of the entity.

14. The method of claim 9, wherein accessing and analyzing further comprises accessing, by the computing device processor, the first database and analyzing, by the computing device processor, at least a portion of the first data to identify future shortfalls in resource needs based on current resources of the entity, current resource inflow of the entity, current resource outflow of the entity and the volume of resources needed for the event.

15. The method of claim 9, further comprising identifying, by a computing device processor, actions that can be taken by the entity to improve at least one of (i) the first ability of the entity to perform the event, and (ii) the second ability of the entity to acquire the resources needed to perform the event.

16. The method of claim 9, further comprising determining, by a computing device processor, one or more third-party entities for providing at least a portion of the event to the entity.

17. A computer program product for predicting resource allocation for an event comprising a non-transitory computer-readable storage medium having computer-executable instructions for:
identifying an event associated with an entity that requires a plurality of resources; and
predicting (i) a first ability of the entity to perform the event, (ii) a volume of resources needed for the entity to perform the event, and (iii) a second ability of the entity to acquire the resources needed to perform the event.

18. The computer program product of claim 17, wherein the instructions for predicting further comprise instructions for determining which entities from amongst a plurality of entities to compare to the entity for the purpose of predicting one or more of (i) the first ability of the entity to perform the event based on current resource capability of the entity, (ii) the volume of resources needed for the event, and (iii) the second ability of the entity to acquire the resources needed to perform the event.

19. The computer program product of claim 17, wherein the instructions for predicting further comprise instructions for predict the volume of resources needed for the entity to perform the event in comparison to current resources of the entity and current resource inflow of the entity.

20. The computer program product of claim 17, further comprising instructions for identifying future shortfalls in resource needs based on current resources of the entity, current resource inflow of the entity, current resource outflow of the entity and the volume of resources needed for the event.
